(19) United States
(12) Patent Application Publication
(10) Pub. No.: US 2008/0313182 A1
(43) Pub. Date: Dec. 18, 2008

(54) METHODS, DEVICES, AND COMPUTER PROGRAM PRODUCTS FOR PREDICTIVE TEXT ENTRY IN MOBILE TERMINALS USING MULTIPLE DATABASES

(75) Inventor: Yojak Harshad Vasa, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/770,040

(22) Filed: Jun. 28, 2007

Related U.S. Application Data
(60) Provisional application No. 60/944,176, filed on Jun. 15, 2007.

(51) Int. Cl. G06F 17/27; G06F 7/04

(52) U.S. Cl. 707/6; 707/E17.015

(57) ABSTRACT

A method of providing a predictive text function in a mobile terminal includes detecting entry of one or more alphanumeric characters via a user interface in a currently-executing first mobile terminal application. At least one character string including the one or more characters is identified among words in a default database associated with the first mobile terminal application and among words in an additional database associated with a second mobile terminal application. The additional database includes at least one word that is not found in the default database. Accordingly, the at least one character string including the one or more characters is displayed via the user interface in the first mobile terminal application. Related devices and computer program products are also discussed.

### CROSS-REFERENCE TO RELATED PATENT APPLICATIONS

This application claims priority from U.S. Provisional Application Ser. No. 60/944,176, filed Jun. 15, 2007, the disclosure of which is hereby incorporated by reference herein in its entirety.

### FIELD OF THE INVENTION

The present invention relates to mobile terminals, and, more particularly, to text entry in mobile terminals.

### BACKGROUND OF THE INVENTION

Electronic devices, such as mobile terminals, increasingly provide a variety of communications, multimedia, and/or data processing capabilities. For example, mobile terminals, such as cellphones, personal digital assistants, and/or laptop computers, may provide access to data in a wide variety of multimedia formats, including text, pictures, music, and/or video.

Text entry in mobile terminals may be difficult due to the limited input devices provided by mobile terminals. For example, while some computing devices, such as personal computers, may include a full QWERTY keyboard for alphanumeric text entry, some mobile terminals may be equipped with limited keyboards where one key can represent more than one alphabetic character. One such system, known as multi-tap, may allow users to enter text using a conventional telephone key pad. More particularly, multi-tap may allow a user to press a key a varying number of times, generally within a limited period of time, to input one of several alphanumeric characters associated with the particular key and the number of times that the key is pressed.

Another system, T9® developed by Tegic Communications, Inc., uses predictive letter patterns to allow a user to (ideally) press each key representing a letter only once to enter a desired alphanumeric string of characters. More particularly, T9® may use a predictive text dictionary and established letter patterns to intelligently ‘guess’ the combination of characters that the user intended to enter. The predictive text dictionary may include a list of words, acronyms, abbreviations, etc., that can be used in the composition of text. As such, possible character string permutations represented by a number of keystrokes entered by a user may be compared to the words in the predictive text dictionary, and a subset of the permutations may be shown to the user via the display to allow selection of the intended character string. The permutations may be sorted by likelihood based on the number of words matched in the predictive text dictionary and/or various metrics maintained for these words, such as frequency of use. Where the possible character string permutations do not match any words in the predictive text dictionary, the set of established letter patterns for a selected language can be applied to suggest the most likely character string permutations. Accordingly, a user may be required to input a number of additional keystrokes in order to enter in a desired word.

It is also known to use predictive text dictionaries to suggest a number of words to the user upon partial entry of a desired word. For example, a word fragment entered by a user in a software application may be compared to words in a predictive text dictionary to determine a list of words matching the pattern of letters provided by the word fragment. The list of words may then be provided to the user as a list of options from which the user can select. Where the word being entered by the user does not appear in the list of words displayed, the user can elect to continue entering in text to complete the word. Similarly, in computing devices with limited keyboards where one keystroke can represent a number of characters (such as T9®), whole words beginning with characters possibly represented by the keystrokes entered are shown to the user.

Despite such known text entry methods and systems, the ease and speed of text entry may not be satisfactory in some circumstances. For example, due to the limited non-volatile memory in some mobile terminals, manufacturers may equip such devices with a pared-down predictive text dictionary, thus reducing the number of words available. In addition, the predictive text dictionary may be populated with words that may be unlikely to be used by a user and/or may not contain other words more likely to be used by that user. As a result, upon entry of a set of keystrokes, the user may be presented with a list of character strings that do not correspond to the word that the user intended to enter. This situation may frustrate and/or slow down the entry of text, and may even result in the insertion of the incorrect words.

As such, some mobile terminals may permit a user to populate the predictive text dictionary with words provided by the user, which may increase the utility of the predictive text dictionary. However such methods of expanding the predictive text dictionary may be relatively slow and/or cumbersome for the user.

### SUMMARY OF THE INVENTION

According to some embodiments of the present invention, methods of providing a predictive text function in a mobile terminal include detecting entry of one or more alphanumeric characters via a user interface a currently executing first mobile terminal application. At least one character string including the one or more characters is identified on words in a default database associated with the first mobile terminal application and words that additional database associated with a second mobile terminal application. The additional database includes at least one word not found in the default database. The at least one character string including the one or more characters is displayed via the user interface in the first mobile terminal application.

In some embodiments, the default database may be queried for the at least one character string responsive to detecting entry of the one or more characters. Also, the additional database may be queried for the at least one character string responsive to detecting entry of the one or more characters. A list of words may be displayed including at least one character string that includes the one or more characters from the default database and at least one character string that includes the one or more characters from the additional database.

In other embodiments, querying of the default database and the additional database may be prioritized. In some embodiments, a user selection indicating a priority for querying the default database and the additional database may be received, and querying of the default database and the additional database may be prioritized responsive to the user selection.

In some embodiments, the at least one character string from the additional database and the at least one character string from the default database may be displayed in an order that is based on the particular database associated therewith.

In other embodiments, the default database may be updated with one or more words from the additional database. The at least one character string may be identified among words in the updated default database. For example, default database may be updated responsive to detecting synchronization of the mobile terminal with another device, addition of a new character string to the additional database, and/or power-up of the mobile terminal.

In some embodiments, the at least one character string may be identified based on words in the additional database responsive to a user selection of the additional database. Also, at least one of the words in the additional database may be entered by a user.

In other embodiments, the at least one character string may be a proper name. Also, the second mobile terminal application may be a contacts, calendar, e-mail, and/or phone book application.

According to further embodiments of the present invention, mobile terminals include a user interface, a memory, a processor, a predictive text module, and a display. The user interface is configured to accept entry of one or more alphanumeric characters responsive to user input in a currently executing first mobile terminal application. The memory includes a default database associated with the first mobile terminal application and an additional database associated with a second mobile terminal application. The additional database includes at least one word not found in the default database. The processor is configured to detect entry of the one or more characters via the user interface. The predictive text module is configured to identify at least one character string including the one or more characters among words in the default database associated with the first mobile terminal application and among words in the additional database associated with the second mobile terminal application. The display is configured to display the at least one character string including the one or more characters in the first mobile terminal application.

In some embodiments, the predictive text module may be configured to query the default database and the additional database for the at least one character string responsive to detecting entry of the one or more characters. The display may be configured to display a list of words including at least one character string that includes the one or more characters from the default database, and at least one character string that includes the one or more characters from the additional database.

In other embodiments, the predictive text module may be configured to prioritize querying of the default database and the additional database. In some embodiments, the user interface may be configured to receive a user selection indicating a priority for querying the default database and the additional database. The predictive text module may be configured to prioritize querying of the default database and the additional database responsive to the user selection.

In some embodiments, the predictive text module may be configured to update the default database with one or more words from the additional database and identifying the at least one character string, words in the updated predictive text database. For example, the written text module may be configured to update the default database responsive to synchronization of the mobile terminal with another device, addition of a new character string to the additional database, and/or upon power-up of the mobile terminal. In some embodiments, the additional database may be a user-defined database.

In other embodiments, the at least one character string may be a proper name. Also, the second mobile terminal application may be a contacts, calendar, e-mail, and/or phone book application.

Although described above primarily with respect to method and electronic device aspects of the present invention, it will be understood that the present invention may be embodied as methods, electronic devices, and/or computer program products.

### BRIEF DESCRIPTION OF THE DRAWINGS

FIG. 1 is a block diagram that illustrates a mobile terminal in accordance with some embodiments of the present invention;

FIG. 2 is a block diagram that illustrates a hardware/software architecture for predictive text entry using multiple databases in a mobile terminal in accordance with some embodiments of the present invention;

FIG. 3 is a flowchart that illustrates example operations for predictive text entry using multiple databases in a mobile terminal in accordance with some embodiments of the present invention; and

FIGS. 4A-4B are block diagrams that illustrate example operations for predictive text entry using multiple databases in a mobile terminal in accordance with some embodiments of the present invention.

### DETAILED DESCRIPTION OF EMBODIMENTS OF THE INVENTION

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. In contrast, when an element is referred to as being “directly coupled” or “directly connected” to another element, there are no intervening elements present. Furthermore, “connected” or “coupled” as used herein may include wirelessly connected or coupled. As used herein, the term “and/or” includes any and all combinations of one or more of the associated listed items, and may be abbreviated as “/”.

It will also be understood that, although the terms first, second, etc. may be used herein to describe various elements, these elements should not be limited by these terms. These terms are only used to distinguish one element from another. For example, a first multimedia device could be termed a second multimedia device, and, similarly, a second multimedia device could be termed a first multimedia device without departing from the teachings of the disclosure.

As will be appreciated by one of skill in the art, the present invention may be embodied as methods, devices, and/or computer program products. Accordingly, the present invention may be embodied in hardware and/or in software (including firmware, resident software, micro-code, etc.). Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package. The program code may execute entirely on a mobile terminal or only partly on the multimedia device and partly on another device. In the latter scenario, the other device may be connected to the multimedia device through a wired and/or wireless local area network (LAN) and/or wide area network (WAN), or the connection may be made to an external computer (for example, through the Internet using an Internet Service Provider).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

For purposes of illustration, embodiments of the present invention are described herein in the context of a mobile terminal. It will be understood, however, that the present invention is not limited to such embodiments and may be embodied generally as any portable electronic device that provides multi-database predictive text entry functionality as described herein.

Some embodiments of the present invention may arise from realization that, although common proper names are included in conventional predictive text dictionaries, such dictionaries typically do not include multi-cultural names. For example, because English databases may typically include only proper names that are commonly used in the Western world, it may be difficult for mobile terminal users to enter non-western names in messages. Also, some predictive text methods where one keystroke can represent a number of characters (such as T9®) may present additional difficulties, as multicultural names may be required to be spelled using nonintuitive methods. In addition, the user may have nicknames and/or other nontraditional names for individuals, and may wish to utilize these names when composing messages on the mobile terminal. Accordingly, some embodiments of the present invention may access one or more additional databases (other than the default database associated with a currently-executing application) to identify character strings that match the alphanumeric characters entered via the user interface of the mobile terminal. For example, when a user enters a string of characters in a text messaging application, a predictive text function according to some embodiments of the present invention may also query a user's phone book database in addition to the default text dictionary associated with text messaging application to find matches. In addition, the default text dictionary may be updated with names from the phone book database. Accordingly, text entry of multi-cultural names may be facilitated.

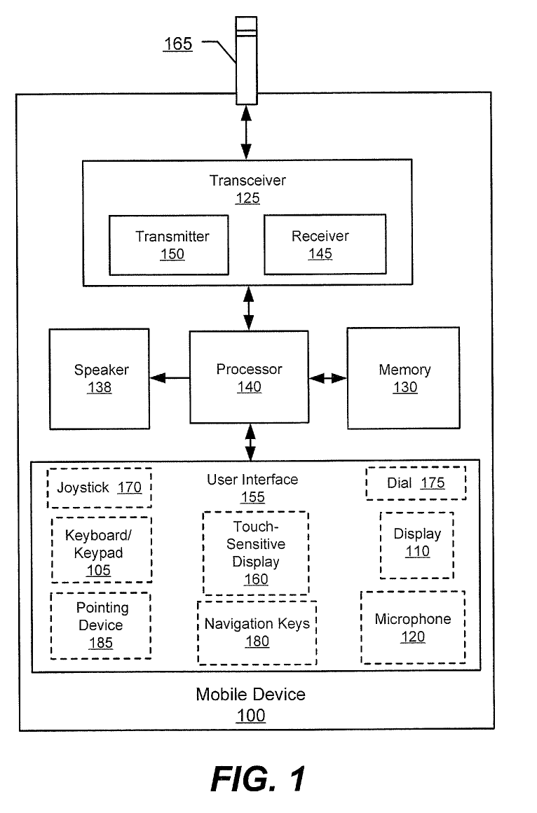

FIG. 1 is a block diagram illustrating a mobile terminal in accordance with some embodiments of the present invention. Referring now to FIG. 1 an exemplary mobile terminal 100 includes a transceiver 125, memory 130, a speaker 135, a processor 140, and a user interface 155. The transceiver 125 typically includes a transmitter circuit 150 and a receiver circuit 145 which cooperate to transmit and receive radio frequency signals to and from base station transceivers via an antenna 165. The radio frequency signals transmitted between the mobile terminal 100 and the base station transceivers may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver 125 may include an infrared (IR) transceiver configured to transmit/receive infrared signals to/from other electronic devices via an IR port. The memory 130 may represent a hierarchy of memory that may include volatile and/or non-volatile memory, such as removable flash, magnetic, and/or optical rewritable non-volatile memory. The processor 140 is coupled to the transceiver 125, the memory 130, the speaker 135, and the user interface 155. The processor 140 may be, for example, a commercially available or custom microprocessor that is configured to coordinate and manage operations of the transceiver 125, the memory 130, the speaker 135, and/or the user interface 155.

As noted above, the mobile terminal 100 may further comprise a user interface 155 coupled to the processor 140. The user interface 155 may include a microphone 120, a display 110 (such as a liquid crystal display), a joystick 170, a keyboard/keypad 105, a touch sensitive display 160, a dial 175, a directional key(s) 180, and/or a pointing device 185 (such as a mouse, trackball, touch pad, etc.). For example, the keyboard/keypad 105 may be operable to define alphanumeric characters/symbols on the display 110. However, depending on functionalities offered by the mobile terminal 100, additional and/or fewer elements of the user interface 155 may actually be provided. For instance, the touch sensitive display 160 may functionally replace a display 110, a keypad 105, and/or a pointing device 185. The touch sensitive display 160 may display a plurality of virtual command and/or control buttons. When application programs are launched and/or executed, the command/control buttons may be selected by touching a stylus on the touch sensitive display 160 at the appropriate location(s) of the virtual buttons shown on the touch sensitive display 160. The foregoing components of the mobile terminal 100 may be included in many conventional mobile terminals and their functionality is generally known to those skilled in the art.

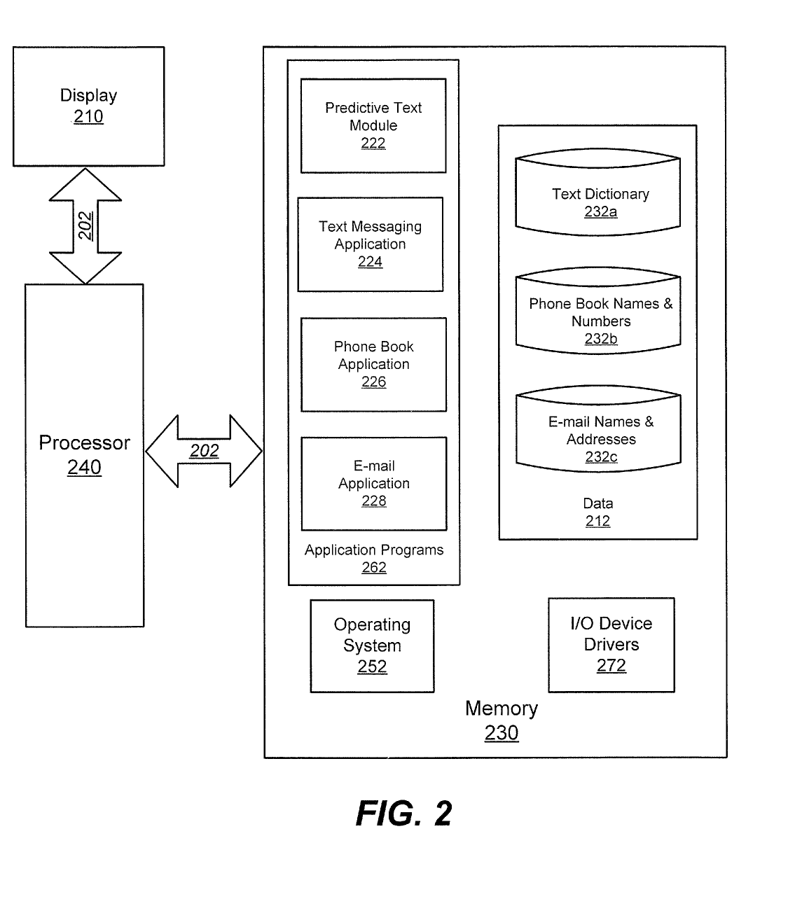

FIG. 2 illustrates a hardware/software architecture including a display 210, a memory device 230, and a processor 240 that may be used for predictive text entry in a mobile terminal, such as the mobile terminal 100 of FIG. 1, according to some embodiments of the present invention. In some embodiments, the processor 240, memory 230, and display 210 may respectively correspond to the processor 140, memory 130, and display 110 of the mobile terminal 100 of FIG. 1.

Referring now to FIG. 2, the processor 240 is configured to communicate with the memory 230 and the display 210 via a data bus 202. The display 210 may be configured to display data that is provided via the processor 240. The memory 230 may be configured to store several categories of software, such as an operating system 252, applications programs 262, and input/output (I/O) device drivers 272. The operating system 252 controls the management and/or operation of system resources and may coordinate execution of programs by the processor 240. The I/O device drivers 272 typically include software routines accessed through the operating system 252 by the application programs 262 to communicate with input/output devices, such as those included in the user interface 155 of FIG. 1, and/or other components of the memory 230. The memory 230 further includes data 212 for the application programs 262 including a plurality of databases 232a-232c.

The application programs 262 are illustrative of programs that implement various features according to embodiments of the present invention, and preferably include at least one application which supports operations for providing a predictive text function. More particularly, the application programs 262 may include a text messaging application 224, a phone book application 226, an e-mail application 228, and a predictive text module 222. In some embodiments, the predictive text module 222 may include an application programming interface (API) that supports requests for predictive text functions from one or more of the application programs 262. For example, upon detecting entry of one or more alphanumeric characters via a user interface of the mobile terminal, one or more of the application programs 262 may utilize the predictive text module 222 to provide a predictive text function based on the entered characters as described in detail below.

The data 212 stored in the memory 230 may include various databases that may be associated with the application programs 262. More particularly, the data 212 may include a text dictionary database 232a, a phone book names and numbers database 232b, and an e-mail names and addresses database 232c. For example, the text dictionary database 232a may be a default database for a predictive text function that is associated with the text messaging application 224. Likewise, the phone book names and numbers database 232b may be the default database for a predictive text function associated with the phone book application 226, and the e-mail names and addresses database 232c may be the default database for a predictive text function associated with the e-mail application 228. Accordingly, in some embodiments of the present invention, different default databases may be associated with different application programs in providing a predictive text function. In other embodiments, however, a single database may be the default database for providing predictive text functions in multiple application programs. Also, one or more of the databases, such as the phone book names and numbers database 232b, and the e-mail names and addresses database 232c, may be user-customizable databases that are configured to accept and store new words, names, and/or other character strings entered by the user. As used herein, a ‘word’ may generically refer to a unit of language including one or more alphanumeric characters, and may include proper names, places/locations, and/or other character strings that may be used to form sentences. The databases 232a-232c may be internally stored in the memory 230 of the mobile terminal; however, the databases 232a-232c may not be necessarily stored in the same physical memory unit. For example, the text dictionary database 232a may be stored in a non-removable memory of the mobile terminal, while the phone book names and numbers database 232b may be stored in a removable memory device associated with the mobile terminal, such as a subscriber identification module (SIM) memory card.

Still referring to FIG. 2, the predictive text module 222 is configured to access multiple ones of the databases 232a-232c in the memory 230 to provide a predictive text function and a currently-executing application program. More particularly, the processor 240 is configured to detect entry of one or more alphanumeric characters via a user interface of the mobile terminal, and the predictive text module 222 is configured to identify at least one character string including the one or more entered characters among words in a default database for a currently-executing one of the application programs 262 and among words in at least one additional database. For example, responsive to entry of several alphanumeric characters in the text messaging application 224, the predictive text module 222 is configured to query the text dictionary database 232a to identify at least one character string among the words in the text dictionary database 232a that includes the entered characters. In addition, the predictive text module 222 is further configured to query one or more additional databases that are associated with different ones of the application programs 262. For instance, responsive to entry of the alphanumeric characters in the text messaging application 224, the predictive text module 222 may be configured to query the phone book names and numbers database 232b and/or the e-mail names and addresses database 232c to identify at least one character string among the words in the databases 232b and/or 232c that include the entered characters.

The predictive text module 222 may also be configured to prioritize querying of the default database associated with the currently executing one of the application programs 262 and the additional database(s). For example, when character strings matching the entered alphanumeric characters are found in both the text dictionary database 232a and the phone book names and numbers database 232b, the predictive text module 222 may be configured to list the matching character string(s) from the phone book names and numbers database 232b with a higher priority than the matching character string(s) from the text dictionary database 232a. More particularly, the predictive text module 222 may provide the matching character strings from the databases 232a and 232b along with the desired priority information to the processor 240, which may then transfer the matching character strings to the display 210 to be displayed in the order specified by the predictive text module 222.

Also, the predictive text module 222 may be configured to prioritize querying of the default and additional databases responsive to receiving a user selection and/or specification indicating which one(s) of the additional databases to query and/or desired priorities associated with querying the additional database(s) via the user interface. For example, a set-up menu associated with the predictive text function in the text messaging application 224 may enable a user to select one or more additional databases that are accessible to the mobile terminal (such as the phone book names and numbers database 232b and/or the e-mail names and addresses database 232c) to be queried in addition to the default text dictionary database 232a. Likewise, set-up menus associated with predictive text functions the phone book application 226 and/or the e-mail application 228 may allow a user to select one or more additional databases to be queried in addition to the default phone book names and numbers database 232b (for the phone book application 226) and/or the default e-mail names and addresses database 232c (for the e-mail application 228). As such, the predictive text module 222 may be configured to query additional databases based on user preferences, which may thereby improve the likelihood that the identified matching character string(s) correspond to the words/names that the user intended to enter.

In addition to and/or instead of querying multiple databases, the predictive text module 222 may be configured to update the default database associated with the currently-executing application with one or more words from the additional databases. For example, upon detecting addition of a new name to the phone book names and numbers database 232b, the predictive text module 222 may add the new name to the text dictionary database 232a. Accordingly, when one or more characters are entered via the user interface in the text messaging application 224, the predictive text module 222 may query the updated text dictionary database 232a to identify one or more character strings that match the entered characters, and may provide the matching character string(s) to the display 210 via the processor 240. The predictive text module 222 may be configured to update the default database associated with the currently-executing one of the application programs 262 periodically, intermittently, and/or at desired times, such as upon power-up of the mobile terminal. The predictive text module 222 may also be configured to update the default database responsive to user actions, such as synchronizing the mobile terminal with another device (for example, a personal computer) and/or addition of a new database entry. In some embodiments, the predictive text module 222 may use a transceiver, such as the transceiver 125 of FIG. 1, to receive and provide updates to one or more of the databases 232a-232c from another electronic device, for example, using a wired, infrared (IR), and/or radio-frequency (RF) connection.

Although FIG. 2 illustrates an exemplary hardware/software architecture that may be used in mobile terminals and/or other electronic devices for providing a predictive text function using multiple databases, it will be understood that the present invention is not limited to such a configuration but is intended to encompass any configuration capable of carrying out operations described herein. For example, although the memory 230 is illustrated as separate from the processor 240, the memory 230 or portions thereof may be considered as a part of the processor 240. Moreover, although illustrated as a single component, the memory 230 may include multiple components, some of which may be physically removable from the mobile terminal, such as a SIM card. More generally, while particular functionalities are shown in particular blocks by way of illustration, functionalities of different blocks and/or portions thereof may be combined, divided, and/or eliminated. Moreover, the functionality of the hardware/software architecture of FIG. 2 may be implemented as a single processor system or a multi-processor system in accordance with various embodiments of the present invention.

Computer program code for carrying out operations of devices and/or systems discussed above with respect to FIG. 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, data processing systems, and/or computer program products in accordance with some embodiments of the invention.

These flowchart and/or block diagrams further illustrate exemplary operations for providing multi-database predictive text entry in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

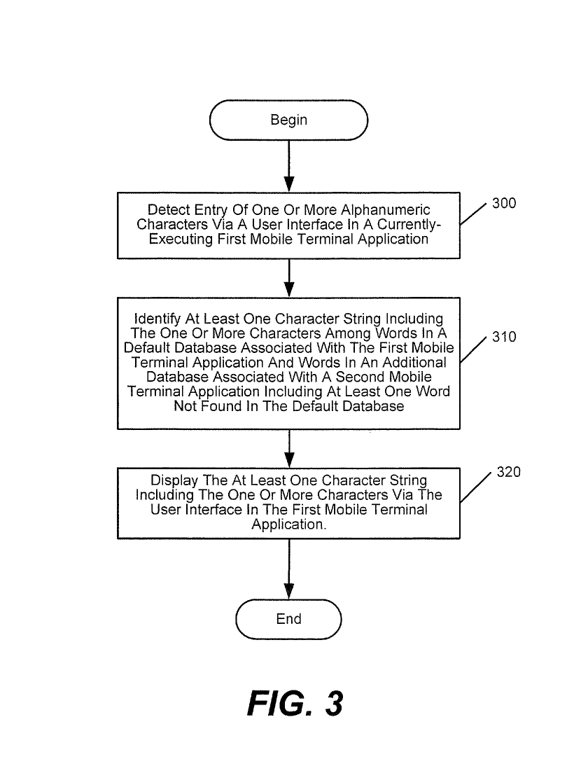

FIG. 3 is a flowchart that illustrates exemplary operations of a mobile terminal for providing a predictive text function using multiple databases in accordance with some embodiments of the present invention.

Referring now to FIG. 3, operations begin upon detecting entry of one or more alphanumeric characters in a currently executing first mobile terminal application (block 300). For example, the alphanumeric characters “Joa” may be entered via the user interface in a text messaging application to define a portion of a proper name, such as Joaquin. At least one character string including the one or more characters is identified among words in a default database associated with the first mobile terminal application, as well as among words in an additional database associated with a second mobile terminal application (block 310). The additional database is not associated with the currently executing application, and includes at least one word not found in the default database. For instance, in addition to a default text dictionary database associated with the text messaging application, an e-mail database including proper names and/or e-mail addresses may be queried for character strings matching the entered characters “Joa”. In addition and/or alternatively, the default text dictionary database may be updated with one or more names from the e-mail database, and the updated default text dictionary database may be queried for character strings matching the entered characters “Joa”. The querying of the additional database(s) and/or the updating of the default database may be performed responsive to a user selection. As such, at least one character string including the one or more entered characters is displayed via the user interface in the currently-executing first mobile terminal application (block 320). More particularly, in the above example, the name “Joan” may be displayed responsive to querying the default text dictionary database, while the name “Joaquin” may be displayed responsive to querying the e-mail database. Thus, the user may select from additional words and/or names which may be more likely to match the word/names intended to be entered by the user. Accordingly, predictive text entry may be facilitated by accessing additional databases beyond the default database associated with a currently-executing application.

The flowchart of FIG. 3 illustrates the architecture, functionality, and operations of embodiments of hardware and/or software in electronic devices, such as mobile terminals, according to some embodiments of the present invention. In this regard, each block represents a module, segment, or portion of code, which comprises one or more executable instructions for implementing the specified logical function(s). It should also be noted that in other implementations, the function(s) noted in the blocks may occur out of the order noted in FIG. 3. For example, two blocks shown in succession may, in fact, be executed substantially concurrently or the blocks may sometimes be executed in the reverse order, depending on the functionality involved.

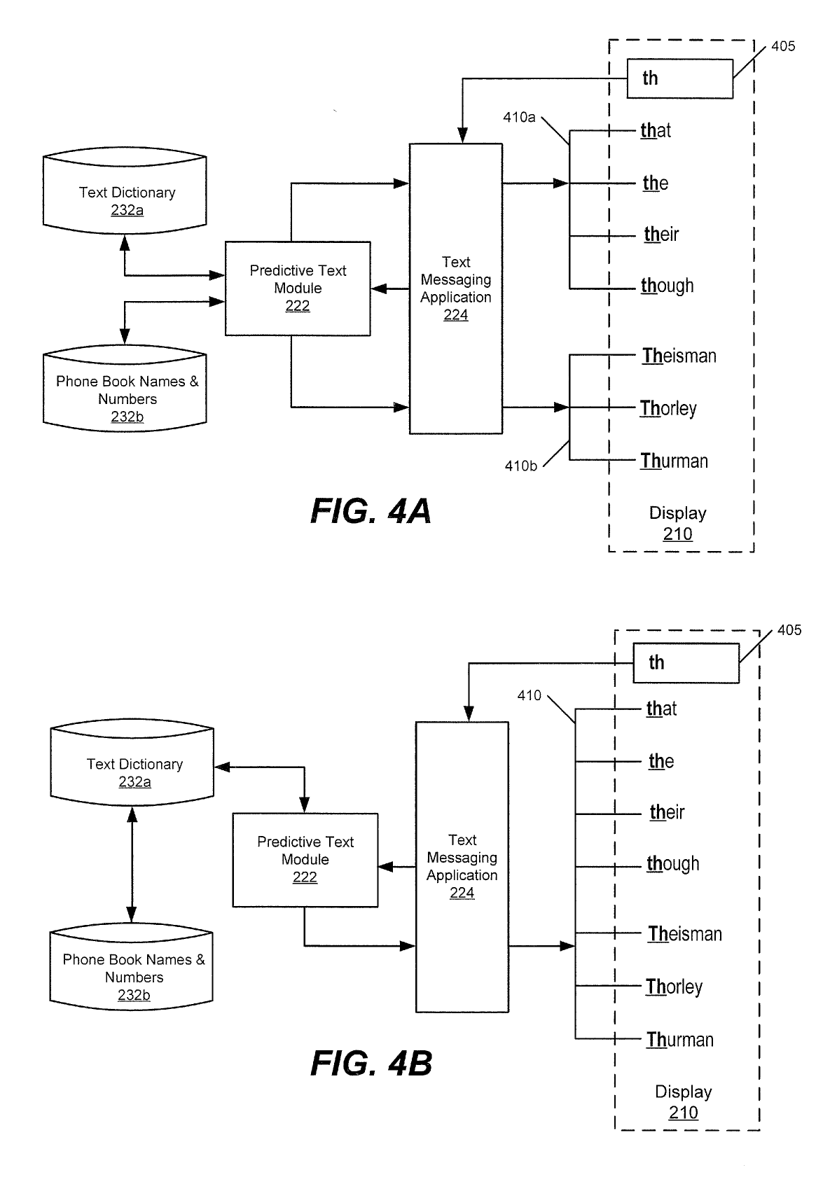

FIGS. 4A and 4B illustrate exemplary operations for providing a predictive text function in a mobile terminal in accordance with some embodiments of the present invention. Referring to FIG. 4A, a character string “th” 405 is entered in a text messaging application 224 via a user interface of the mobile terminal. The entered characters “th” 405 are provided to a predictive text module 222 that provides a predictive text function for the text messaging application 224. In response to entry of the characters “th” 405, the predictive text module 222 queries a default database associated with the text messaging application 224 (i.e., text dictionary database 232a) as well as an additional database associated with a different application (i.e., phone book names and numbers database 232b) to identify one or more character strings among the words in both databases 232a and 232b that include the entered characters. More particularly, the predictive text module 222 identifies four words (that, the, their, though) from the default text dictionary database 232a and three proper names (Theisman, Thorley, Thurman) from the phone book names and numbers database 232b that include the entered characters “th” 405.

Still referring to FIG. 4A, the predictive text module 222 returns a list of matching words from the default database and the additional database, which are provided to the user via the display 210. More particularly, the predictive text module 222 provides a first list of words 410a that include the entered characters “th” 405 from the default text dictionary database 232a via the display 210. In addition, the predictive text module 222 provides a second list of words 410b that include the entered characters “th” 405 from the phone book names and numbers database 232b via the display 210. As such, the predictive text module 222 provides the user with a list of matching proper names 410b from the user's phone book names and numbers database 232b in addition to the list of matching words 410a from the default text dictionary database 232a that is associated with the text messaging application 224. In other words, the predictive text module 222 creates a supplementary tree structure 410b listing proper names likely to be used by the user in addition to the initial tree structure 410a listing words from the default database. Thus, the proper names Theisman, Thorley, and Thurman are added to the choices from the default database from which the user may select in order to enter a desired word/name. For example, the supplementary tree structure may be used to provide words from the additional database when the default database has been optimized and/or where it is otherwise impractical to add words to the default database. The choices from both databases 232a and 232b may be displayed to the user via the display 210 in alphabetical order, or alternatively, as shown in FIG. 4A, in the order of words from the default database followed by words from the additional database. Also, as noted above, the user of the mobile terminal may prioritize querying of the phone book names and numbers database 232b over the text dictionary database 232a such that the list 410b of matching words from the phone book names and numbers database 232b may be displayed with a higher priority than the list 410a of matching words from the text dictionary database 232a via the display 210.

FIG. 4B illustrates an exemplary operations for providing a multi-database predictive text function where the predictive text module 222 returns a single list of matching words 410 via the display 210 responsive to entry of the characters “th” 405 by a user of the mobile terminal. For example, as shown in FIG. 4B, the predictive text module 222 updates the default database associated with the text messaging application (i.e., text dictionary database 232a) with one or more words from an additional database (i.e., phone book names and numbers database 232b), and queries the updated database to identify one or more character strings among the words in the updated database that include the entered characters. More particularly, the predictive text module 222 updates the text dictionary database 232a with three proper names (Theisman, Thorley, and Thurman) from the phone book names and numbers database 232b, and provides a single list of matching words and names 410 that include the entered characters “th” 405 via the display 210. In other words, the predictive text module 222 employs a single tree structure provide a list of matching words from the updated text dictionary database 232a that are descendants of the entered characters “th” 405. Thus, by updating the text dictionary database 232a with entries from the phone book names and numbers database 232b, new “leaves” in the tree structure representing proper names from the phone book names and numbers database 232b are created.

Still referring to FIG. 4B, the default text dictionary database 232a may be updated periodically, intermittently, at predetermined times, and/or responsive to a user action and/or command. For example, the predictive text module 222 may update the text dictionary database 232a upon power-up of the mobile terminal, upon synchronizing the mobile terminal with another device, and/or upon adding a new contact to the phone book names and numbers database 232b. The predictive text module 222 may also be configured to update the text dictionary database 232a with words, names, and/or other character strings from one or more databases included in the internal memory of the mobile terminal and/or otherwise associated with the mobile terminal. For example, where a SIM card includes the phone book names and numbers database 232b, the predictive text module 222 may update the text dictionary database 232a with the names from the SIM card. Similarly, responsive to synchronizing the mobile terminal with a network address book, the predictive text module 222 may update the text dictionary database 232a with proper names from the network address book provided by the synchronization process. In contrast, conventional databases associated with predictive text entry may require a user to manually enter such names in order to update the conventional database, which may be time consuming and/or otherwise impractical for the user.

Accordingly, some embodiments of the present invention may provide improved predictive text entry functionality by accessing one or more additional databases in addition to a default database that is associated with the predictive text entry function of a currently-executing mobile terminal application. More particularly, in some embodiments where a user wishes to enter a multi-cultural name that is not included in a default database associated with a mobile terminal application, embodiments of the present invention may access a personalized and/or user customizable database (such as a phone book and/or e-mail database) in addition to the default database to provide the user with a list of character strings that may more likely match the words and/or names that the user intended to enter.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A method of providing a predictive text function in a mobile terminal, the method comprising:
detecting entry of one or more alphanumeric characters via a user interface in a currently-executing first mobile terminal application;
identifying at least one character string including the one or more characters among words in a default database associated with the first mobile terminal application and words in an additional database associated with a second mobile terminal application including at least one word not found in the default database; and
displaying the at least one character string including the one or more characters via the user interface in the first mobile terminal application.

2. The method of claim 1, wherein identifying the at least one character string comprises:
querying the default database for the at least one character string responsive to detecting entry of the one or more characters; and
querying the additional database for the at least one character string responsive to detecting entry of the one or more characters,
wherein displaying the at least one character string comprises displaying a list of words including at least one character string that includes the one or more characters from the default database and at least one character string that includes the one or more characters from the additional database.

3. The method of claim 2, wherein querying of the default database and the additional database is prioritized.

4. The method of claim 3, further comprising:
receiving a user selection indicating a priority for querying the default database and the additional database,
wherein querying of the default database and the additional database is prioritized responsive to the user selection.

5. The method of claim 4, wherein displaying the list of words comprises:
displaying the at least one character string from the additional database and the at least one character string from the default database in an order that is based on the particular database associated therewith.

6. The method of claim 1, wherein identifying at least one word comprises:
updating the default database with one or more words from the additional database; and
identifying the at least one character string among words in the updated default database.

7. The method of claim 6, wherein updating the default database comprises:
updating the default database responsive to detecting synchronization of the mobile terminal with another device, addition of a new character string to the additional database, and/or power-up of the mobile terminal.

8. The method of claim 1, wherein identifying the at least one word further comprises:
identifying the at least one character string based on words in the additional database responsive to a user selection of the additional database.

9. The method of claim 1, wherein at least one of the words in the additional database is entered by a user.

10. The method of claim 1, wherein the at least one character string comprises a proper name, and wherein the second mobile terminal application comprises a contacts, calendar, e-mail, and/or phone book application.

11. A mobile terminal, comprising:
a user interface configured to accept entry of one or more alphanumeric characters responsive to a user input in a currently-executing first mobile terminal application;
a memory including a default database associated with the first mobile terminal application and an additional database associated with a second mobile terminal application and including at least one word not found in the default database;
a processor configured to detect entry of the one or more characters via the user interface;
a predictive text module configured to identify at least one character string including the one or more characters among words in the default database associated with the first mobile terminal application and among words in the additional database associated with the second mobile terminal application; and
a display configured to display the at least one character string including the one or more characters in the first mobile terminal application.

12. The mobile terminal of claim 11, wherein the predictive text module is configured to query the default database and the additional database for the at least one character string responsive to detecting entry of the one or more characters, and wherein the display is configured to display a list of words including at least one character string that includes the one or more characters from the default database and at least one character string that includes the one or more characters from the additional database.

13. The mobile terminal of claim 12, wherein the predictive text module is configured to prioritize querying of the default database and the additional database.

14. The mobile terminal of claim 13, wherein the user interface is configured to receive a user selection indicating a priority for querying the default database and the additional database, and wherein the predictive text module is configured to prioritize querying of the default database and the additional database responsive to the user selection.

15. The mobile terminal of claim 11, wherein the predictive text module is configured to update the default database with one or more words from the additional database and identify the at least one character string among words in the updated predictive text database.

16. The mobile terminal of claim 15, wherein the predictive text module is configured to update the default database responsive to synchronization of the mobile terminal with another device, addition of a new character string to the additional database, and/or upon power-up of the mobile terminal.

17. The mobile terminal of claim 11, wherein the additional database comprises a user-defined database.

18. The mobile terminal of claim 11, wherein the at least one character string comprises a proper name, and wherein the second mobile terminal application comprises a contacts, calendar, e-mail, and/or phone book application.

19. A computer program product providing a predictive text function in a mobile terminal, the computer program product comprising:
a computer readable storage medium having computer readable program code embodied in said medium, said computer readable program code comprising:
computer readable program code that detects entry of one or more alphanumeric characters via a user interface in a currently-executing first mobile terminal application;
computer readable program code that identifies at least one character string including the one or more characters among words in a default database associated with the first mobile terminal application and among words in an additional database associated with a second mobile terminal application including at least one word not found in the default database; and
computer readable program code that displays the at least one character string including the one or more characters via the user interface in the first mobile terminal application.

20. The computer program product of claim 19, further comprising:
computer readable program code that querys the default database and the additional database for the at least one character string responsive to detecting entry of the one or more characters; and
computer readable program code that displays a list of words including at least one character string that includes the one or more characters from the default database and at least one character string that includes the one or more characters from the additional database.
